(19) United States
(12) Patent Application Publication
(10) Pub. No.: US 2008/0301088 A1
(43) Pub. Date: Dec. 4, 2008

(54) SYSTEM AND METHOD FOR APPLICATION OF LAWS

(76) Inventors: John M. Landry, Jupiter, FL (US); Jarrod Petrelli, West Palm Beach, FL (US)

Correspondence Address: AKERMAN SENTERFITT, P.O. BOX 3188, WEST PALM BEACH, FL, 33402-3188, US

(21) Appl. No.: 11/755,056

(22) Filed: May 30, 2007

(51) Int. Cl. G06F 17/30; G06F 17/16

(52) U.S. Cl. 707/3; 709/203; 707/E17.014

(57) ABSTRACT

A system and method for determining a law that has been violated by a suspect is provided. The system and method can have a user interface to receive user inputs and to present queries and a plurality of answers to each of the queries, with the user inputs being selections of the plurality of answers; and a processor to determine a next one of the queries to be presented based on a selection of one of the plurality of answers to a previous query and to determine the law that has been violated based on each of the selections of the plurality of answers. The processor can be in communication with the user interface. The queries can be based on elements of the law. The user interface can present the law that has been violated.

### FIELD OF THE INVENTION

The embodiments of the invention herein relate to analysis of laws, and more particularly to a system and method for application of laws.

### BACKGROUND

The application of facts to a set of laws, rules or regulations to determine a violation of the laws, rules or regulations can be a difficult and time-consuming task. This task can be exacerbated by the surroundings of the individual trying to apply the facts. For example, a police officer who has apprehended a suspect may spend a great deal of time going through a hardcopy of the criminal statutes to see what crimes have been violated by the suspect. This process can be error prone and cumbersome, especially where the police officer is still in the field. If the police officer returns to the station house to consult the criminal statutes then a return to the scene of the crime may be necessary for additional fact finding, such as where an element of the crime requires a school to be within a certain distance.

Electronic legal research tools exist for searching laws and caselaw. However, these tools utilize search engines based upon word searches. Formulating the correct search string to cover the particular fact pattern can be a difficult process and can also be error prone. Additionally, such search results often give numerous results without any finality provided to the user as to which, if any, of the statutes he or she should choose. The user must then go back through each of the search results and analyze all of the elements to verify that the law has been violated.

A need therefore exists for a system and method that accurately and efficiently assists a user in applying a set of facts to a law to determine if the law has been violated.

### SUMMARY OF THE INVENTION

Broadly stated, embodiments of the invention are directed to a system and method that allows a user to apply a set of facts to a law to determine if the law has been violated. The system and method present one or more queries along with a plurality of answers to each of the queries, and receives selections of the answers. The queries can be based upon previously selected answers using a decision-flow process or method.

In one embodiment, a system is provided for determining a law that has been violated by a suspect. The system can include a user interface to receive user inputs and to present queries and a plurality of answers to each of the queries, wherein the user inputs are selections of the plurality of answers; and a processor to determine a next one of the queries to be presented based on a selection of one of the plurality of answers to a previous query and to determine the law that has been violated based on each of the selections of the plurality of answers. The processor can be in communication with the user interface. The queries can be based on elements of the law. The user interface can present the law that has been violated.

In another embodiment, a communication device is provided having a controller to receive user inputs and to present queries and a plurality of answers to each of the queries. The user inputs can be selections of the plurality of answers. The controller can determine a next one of the queries to be presented based on a selection of one of the plurality of answers to a previous query. The controller can determine a law that has been violated by a suspect based on each of the selections of the plurality of answers. The queries can be based on elements of the law. The controller can present the law that has been violated.

In yet another embodiment, a computer readable program is provided. The computer readable program is embodied in an article of manufacture comprising computer readable program instructions for determining a law that has been violated by a suspect. The program can include program instructions for causing the computer to present queries and a plurality of answers to each of the queries, wherein the queries are based on elements of the law; program instructions for causing the computer to receive user inputs comprising selections of the plurality of answers; program instructions for causing the computer to determine a next one of the queries to be presented based on a selection of one of the plurality of answers to a previous query; and program instructions for causing the computer to determine the law that has been violated based on each of the selections of the plurality of answers.

In a further embodiment, a method is provided for determining a criminal law or traffic ordinance that has been violated. The method can include presenting on a user interface a plurality of categories of criminal laws or traffic ordinances, wherein the plurality of categories use one or more terms that are associated with the elements of the criminal law or traffic ordinance; presenting on the user interface a plurality of sub-categories of criminal laws or traffic ordinances, wherein the plurality of sub-categories are determined based on a selection of one of the plurality of categories, wherein the plurality of sub-categories use one or more terms that are associated with the elements of the criminal law or traffic ordinance; and presenting on the user interface the criminal law or traffic ordinance that has been violated based upon the selection of the plurality of categories and sub-categories.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a system for application of laws in accordance with an embodiment of the inventive arrangements;

FIG. 2 is a graphical user interface of the system of FIG. 1;

FIG. 3 is a graphical user interface of the system of FIG. 1;

FIG. 4 is a graphical user interface of the system of FIG. 1;

FIG. 5 is a graphical user interface of the system of FIG. 1;

FIG. 6 is a graphical user interface of the system of FIG. 1;

FIG. 7 is a graphical user interface of the system of FIG. 1;

FIG. 8 is a graphical user interface of the system of FIG. 1;

FIG. 9 is a graphical user interface of the system of FIG. 1;

FIG. 10 is a graphical user interface of the system of FIG. 1;

FIG. 11 is a graphical user interface of the system of FIG. 1;

FIG. 12 is a graphical user interface of the system of FIG. 1;

FIG. 13 is a graphical user interface of the system of FIG. 1;

FIG. 14 is a graphical user interface of the system of FIG. 1; and

FIG. 15 is a graphical user interface of the system of FIG. 1.

### DETAILED DESCRIPTION

While the specification concludes with claims defining the features of the embodiments of the invention that are regarded as novel, it is believed that the system and other embodiments will be better understood from a consideration of the following description in conjunction with the drawing figures.

As required, detailed embodiments of the present system are disclosed herein. However, it is to be understood that the disclosed embodiments are merely exemplary, and can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an” as used herein, are defined as one or more than one. The term “plurality” as used herein, is defined as two or more than two. The term “another” as used herein, is defined as at least a second or more. The terms “including” and/or “having” as used herein, are defined as comprising (i.e., open language).

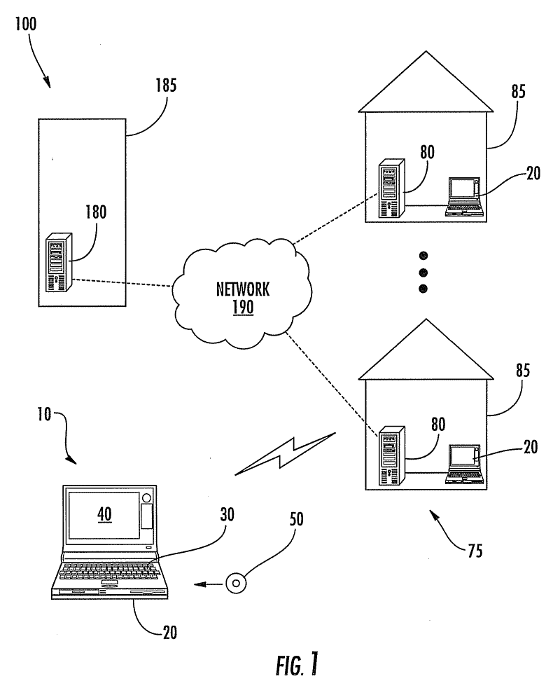

Referring to FIG. 1, an exemplary embodiment of a system for identifying and/or applying laws is provided and generally referred to by reference numeral 10. The term “laws” as used herein is intended to include any statute, ordinance, regulation, rule, policy, guideline, order, ruling and/or directive provided by any entity, including governmental agencies, private entities, public entities, domestic entities and foreign entities, and can be written or unwritten. For purposes of illustration, system 10 is described with respect to the Florida State Statutes (“FSS”) that addresses criminal actions. However, the present disclosure also contemplates other embodiments of system 10 based upon other laws of any governmental body within or outside of the United States, as well as laws of other entities, such as rules of a corporation or association.

System 10 can include a communication device 20 having a user interface for inputting of information relevant to a particular set of laws associated with the user, such as the FSS for a police officer. The communication device 20 can process the inputted information and present closed-ended questions or queries to the user to provide the user with a particular FSS that has been violated based upon a particular set of facts.

In one embodiment, the communication device 20 can be a lap-top computer including a display 40. The communication device 20 can comprise a communications interface that utilizes common technology for communicating with other computing devices, such as over an IP interface with a network. The communication device 20 can further comprise a memory (such as a high capacity storage medium), and a processor or controller that makes use of computing technology for controlling operations of the communication device.

The user can input information, including answers to questions that are associated with each of the FSS, such as through use of the user interface 30, which can include one or more of a touch-sensitive screen, a keyboard a mouse or other input device or technique. The lap-top computer can be used in the field by the police officer while the facts surrounding an incident are fresh in the police officer's mind and while additional fact finding in the surroundings are readily available. The fact findings can be directly related to a question and number of answers presented by system 10, such as a question presented regarding a crime occurring in a particular location including a school, church or playground. The computer lap-top can also be taken back to the station house to continue with the use of system 10 to arrive at the particular FSS that has been violated based upon the particular set of facts.

In one embodiment, the communication device 20 can include speech recognition software and components so that a user can verbally input information into the user interface 30 of the communication device. In another embodiment, the communication device 20 can present information to the user audibly. The present disclosure also contemplates the use of other communication devices to be used to process inputted information and present closed-ended questions to the user, such as a PDA, desk-top computer, dedicated processor and others.

Communication device 20 can include a computer-readable storage medium 50 having computer instructions for processing the inputted information and presenting the closed-ended questions to the user in order to provide the user with a particular FSS that has been violated based upon a particular set of facts. The storage medium 50 can be a removable storage medium, such as a CD-ROM, or can be incorporated into the communication device 20, such as an integrated circuit. In one embodiment, the communication device 20 can be a dedicated device that processes the inputted information and presents the closed-ended questions to the user.

System 10 can include a server-based application 75 that provides the processing for the inputted information and the presenting of the closed-ended questions to the user at the communication device 20 in order to provide the user with the particular FSS that has been violated based upon the particular set of facts. The server-based application 75 can be run on a processing server 80 at a remote location (e.g., a central location), such as station-house 85, that receives user inputs via a wireless and/or wireline transmission from one or more communication devices 20 that are in the field. The server-based application can present the closed-ended questions to the user at the communication device in order to provide the user with the particular FSS that has been violated based upon the particular set of facts. The server-based application 75 can utilize a number of access technologies or combinations of access technologies, such as GSM-GPRS, EDGE, CDMA-1X, UMTS, WiMAX, software defined radio (SDR), and other known and future technologies, as well as broadband services, such as DSL, VoIP (Voice over Internet Protocol), IPTV (Internet Protocol Television), Internet services, and so on, to establish communication between the server 80 and the communication device 20. The server 80 can communicate with one or more other communication devices 20 that are located in the station-house 85, such as desk-top computers. This allows use of the system 10 in multiple locations, such as initially in the field and then later back at the station-house 85.

System 10 can include a web-based application 100 that provides the processing for the inputted information and the presenting of the closed-ended questions to the user at the communication device 20 in order to provide the user with the particular FSS that has been violated based upon the particular set of facts. The web-based application 100 can be run on a processing server 180 at a remote location 185 (e.g., central location) that receives user inputs via a wireless and/or wireline transmission from one or more communication devices 20 that are in the field. The web-based application 100 can present the closed-ended questions to the user at the communication device 20 in order to provide the user with the particular FSS that has been violated based upon the particular set of facts. In one embodiment, the Web-based application 100 communicates over a network 190, such as the internet, with one or more station houses 85 which can relay the data utilizing a number of access technologies or combinations of access technologies, such as GSM-GPRS, EDGE, CDMA-1X, UMTS, WiMAX, software defined radio (SDR), and other known and future technologies, as well as broadband services, such as DSL, VoIP (Voice over Internet Protocol), IPTV (Internet Protocol Television), Internet services, and so on, to establish communication between the server 180 and the communication devices 20. In another embodiment, the web-based application 100 can communicate directly with the one or more communication devices 20. The present disclosure also contemplates other configurations of communication for the one or more communication devices 20.

While the exemplary embodiment of FIG. 1 shows the storage medium 50, the server-based application 75 and the web-based application 100 operating together, it should be understood that each of the storage medium, the server-based application and the web-based application can be used alone or in combination with each other to communicate directly with the one or more communication devices 20 in order for system 10 to provide the user with the particular FSS that has been violated based upon the particular set of facts. The present disclosure also contemplates other configurations of the one or more communication devices 20 with one or more of the storage medium 50, the server-based application 75 and the web-based application 100. For example, a station house 85 can have a plurality of server-based applications 75, where one of the server-based applications handles a first set of laws (e.g., traffic ordinances) and another of the server-based applications handles a second set of laws (e.g., criminal statutes). Each of the server-based applications 75 can be in communication with all of the communication devices 20 or can be in communication with only designated communication devices, such as a first set of communication device handling traffic ordinances and a second set of communication device handling criminal statutes.

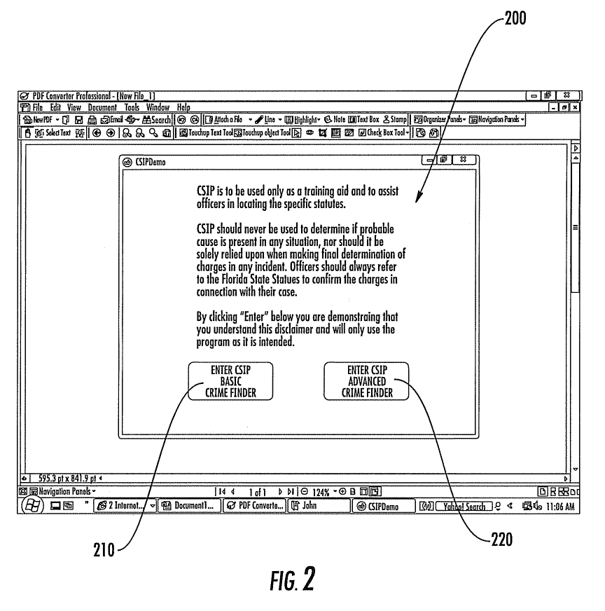

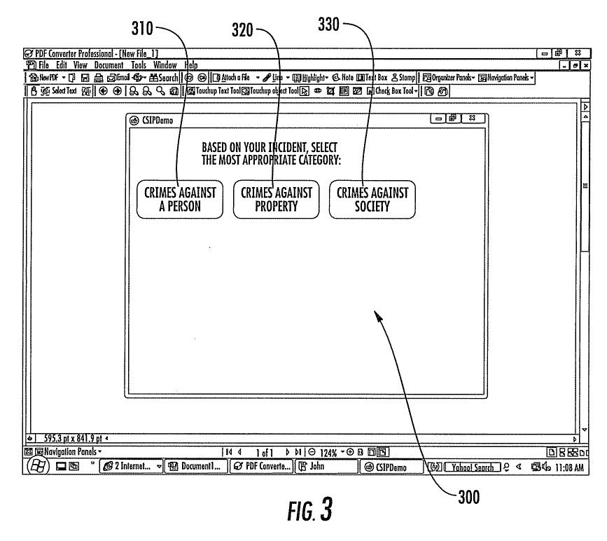

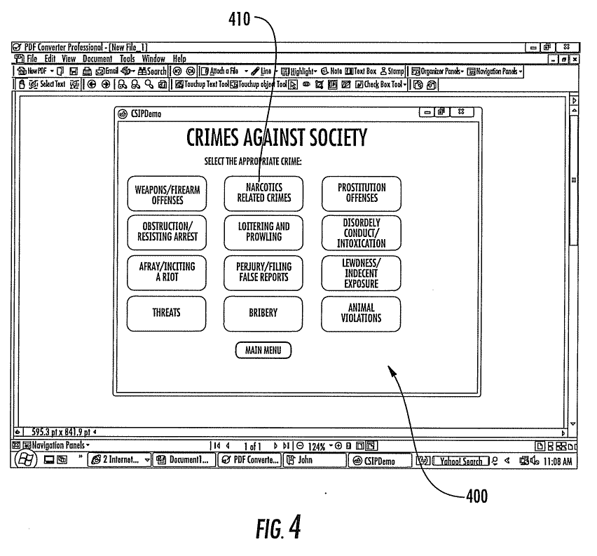

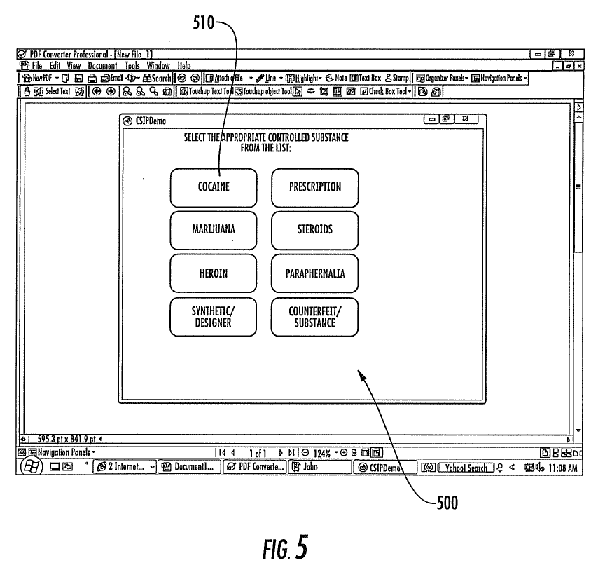

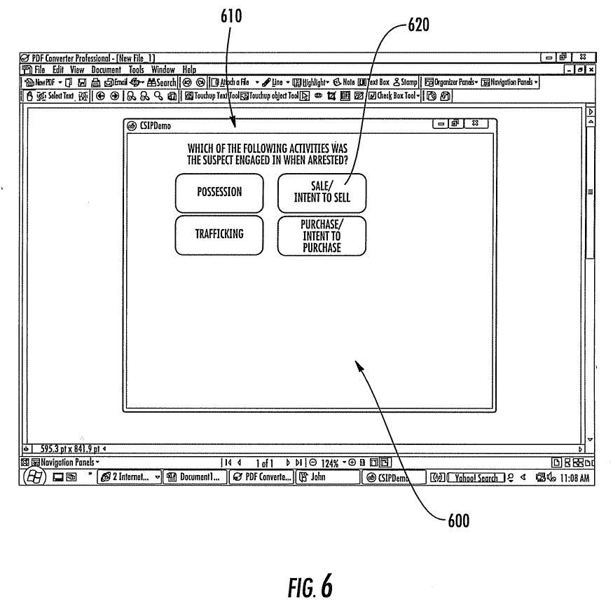

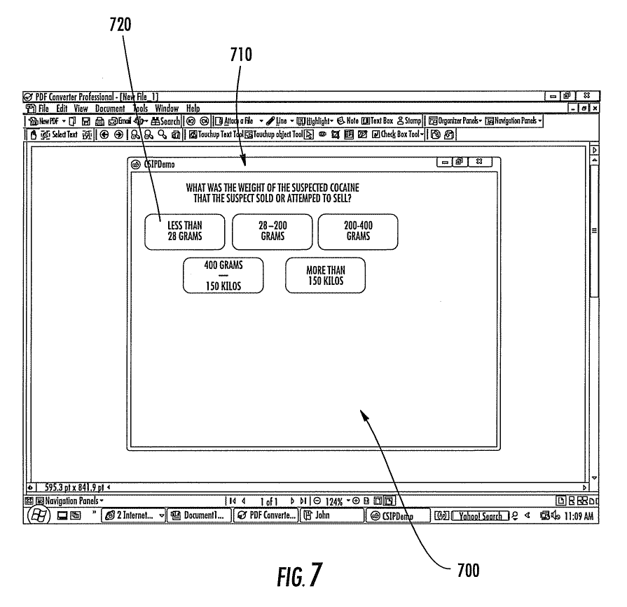

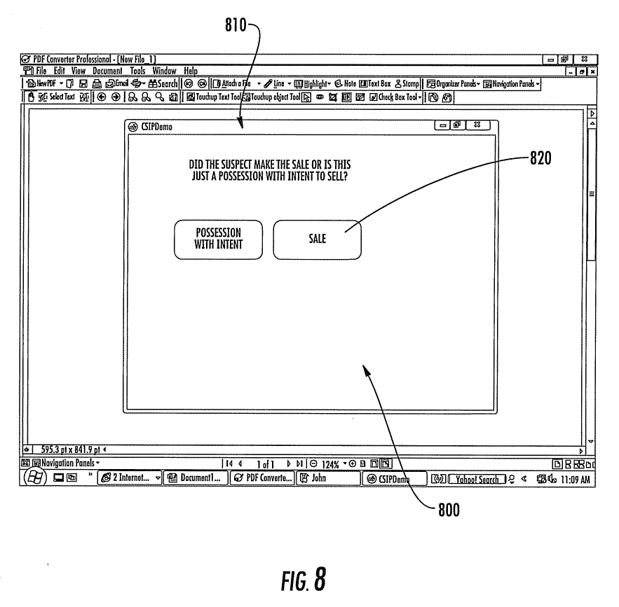

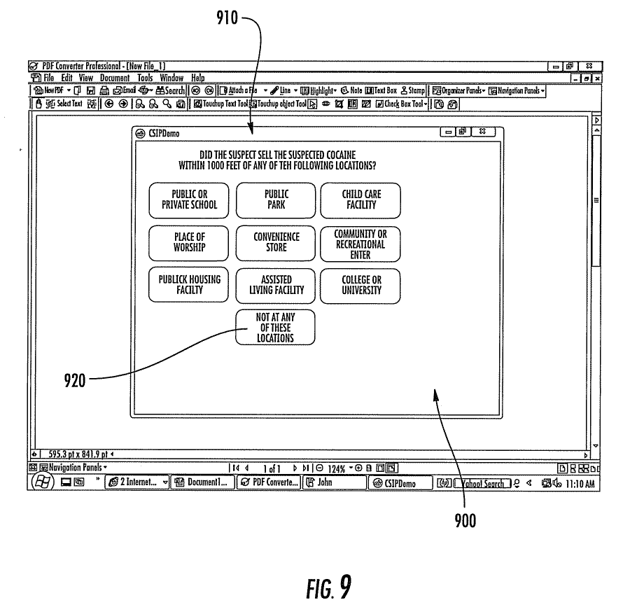

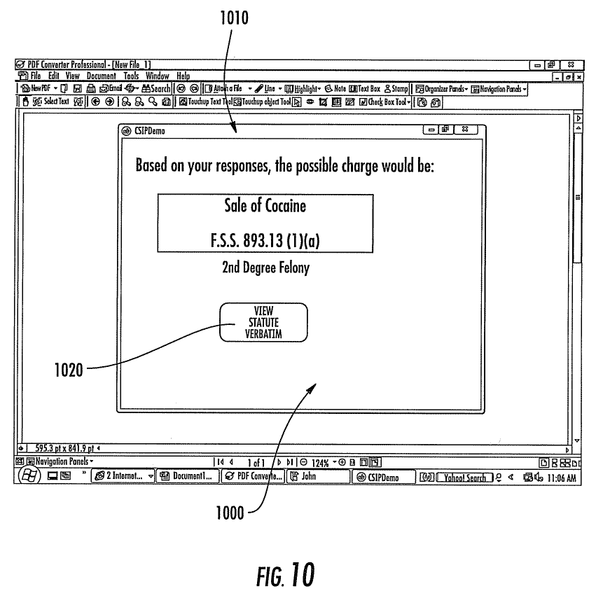

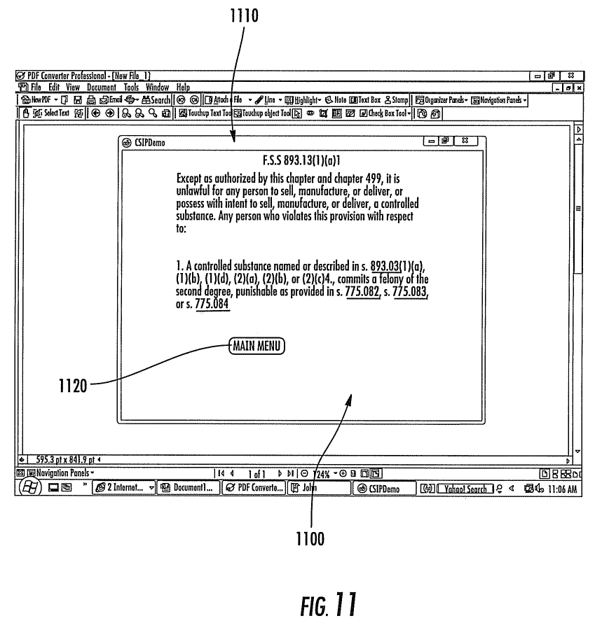

Referring additionally to FIGS. 2-11, system 10 can provide a user with a graphical user interface (“GUI”) that facilitates the police officer inputting information associated with the facts surrounding a particular violation of a FSS. GUI 200 allows a police officer to select between a basic mode 210, where a FSS is eventually displayed through choices of titles, and an advanced mode 220, where closed-ended questions are answered by the police officer to arrive at the appropriate FSS. GUI 300 provides selections 310-330 of types of crimes including crimes against a person, crimes against property and crimes against society. The types of crimes can be broken into other categories such as crimes against the state and crimes against public order and morals. Further sub-categories can also be included for each of the above-referenced categories of crimes to allow more focused closed-ended questions.

In one embodiment, where the user selects the basic mode 210 from GUI 200, a list of categories of crimes or traffic violations can be presented. This list can be in alphabetical order and based upon common-language terms associated with the crime or violation, such as “broken headlight.” A user can select the common-language term and be provided with sub-categories of crimes or violations to select. Basic mode 210 can provide the verbatim criminal statute or traffic ordinance that has been violated. In one embodiment, basic mode 210 can generate a traffic ticket based upon the violation that was ascertained by the above-described process. The common-language terms can be based upon more-readily recognizable language than is found in the title of the criminal statute or traffic ordinance, which may or may not be found in the body of the criminal statute or traffic ordinance.

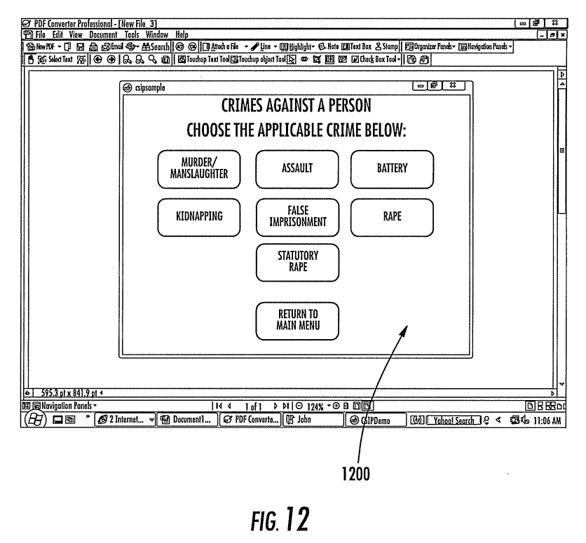

In the exemplary embodiment of system 10, a police officer can choose the advanced mode 220 and can then choose a category of crimes, such as selection 320 for crimes against society. The selection can be made by touching the corresponding selection on the screen, although other user interfaces are contemplated, including speech recognition. GUI 400 can provide the police officer with additional selections of sub-categories of crimes, such as narcotics related crimes in selection 410. Other sub-categories can include weapons/firearm offenses, obstruction/resisting arrest, afray/inciting riot, threats, loitering/prowling, perjury/filing false reports, bribery, prostitution, disorderly conduct/intoxication, lewdness/indecent exposure and animal violations. If the police officer had chosen the selection for crimes against a person then GUI 1200, as shown in FIG. 12, can present sub-categories of crimes such as murder/manslaughter, assault, battery, kidnapping, false imprisonment, rape, and statutory rape.

Referring back to FIGS. 1-11, after the police officer has depressed selection 410, GUI 500 can provide a choice of the types of narcotic that were involved in the set of facts, such as selection 510 for cocaine. System 10 can begin asking closed-ended questions that are relevant to the facts surrounding the incident and are associated with the type of crime that was violated. For example, GUI 600 can present question 610, such as the type of activity the suspect was engaged in at the time of the arrest, and can present a list of available answers, such as selection 620 for sale/intent to sell. Other selections can be presented including possession, trafficking, and purchase/intent to purchase. The questions and/or answers can be presented in one or more terms that are more readily understandable to the police officer rather than terms typically found in the FSS.

After the police officer has chosen an answer, such as selection 620, GUI 700 can present question 710, such as the weight of the cocaine, and can present a list of available answers, such as selection 720 for less than 28 grams. Other selections can be presented including various ranges of weights corresponding to various portions of the FSS. In response to the police officer's choosing of selection 720, GUI 800 can present question 810, such as whether the sale occurred or whether it was an intent to sell, and can present a list of available answers, such as selection 820 for the sale occurring. Other selections can be presented including various aspects related to a sale corresponding to various portions of the FSS.

In response to the police officer's choosing of selection 820, GUI 900 can present question 910, such as whether the sale occurred in a location that would be an aggravation of the crime, and can present a list of available answers, such as selection 920 for none of the listed locations. Other selections can be presented that are associated with aggravating locations, such as schools, churches, parks, child care facilities, convenience stores, public housing, assisted living facilities, and colleges, corresponding to various portions of the FSS.

In response to the police officer's choosing of selection 920, GUI 1000 can present the possible charge 1010, such as sale of cocaine pursuant to F.S.S. 893.23 (1)(a) (2^{nd} Degree Felony). The police officer can choose to see the verbatim statute by depressing selection 1020. In response to the police officer's choosing of selection 1020, GUI 1100 can present the verbatim statute at 1110 and provide a selection 1120 for returning for further processing of a different set of facts related to a possible crime. In one embodiment, system 10 can print the verbatim statute that was arrived at by the process described-above.

In another embodiment, system 10 can process paperwork, such as an arrest template, associated with the arrest based at least in part on the statute 1110 determined using this process. In another embodiment, the statute 1110 can be communicated to the server 80 for generation of the arrest template, where additional information can then be filled in by the police officer or someone else. In yet another embodiment, after presenting the statute 1110, system 10 can request additional information associated with the crime, including suspect identification, time, and location, as well as any other information used in generating the paperwork necessary for an arrest of the suspect, and can utilize this information in generating the paperwork. The paperwork can be communicated to the server 80 for electronic storage, generating a hardcopy or both.

In one embodiment, system 10 can interface with one or more other computer programs for generation of reports or other documents associated with the arrest. For example, system 10 can communicate the relevant statute that has been violated to a report-generating program, which in turn can generate a template for the arrest. Various application programming interfaces (APIs) can be used for communication between system 10 and one or more other computer programs, such as Single UNIX Specification and Microsoft Windows API.

System 10 can provide a series of closed-ended questions that are associated with specific elements of the crime as delineated in the FSS, and can utilize commonly used terms to facilitate the police officer's interaction with the system. The terms that are used in the queries or the criteria that is being queried can vary depending upon the particular law that is being processed by system 10. In one embodiment, the queries can be pre-determined and can be sequentially reached based upon the answer chosen for the previous query.

The system 10 can present the questions in a logical order to walk through each of the elements of the crime, including any possible aggravating or mitigating circumstances, so that the police officer can sequentially answer each question to arrive at the FSS that was violated. The queries can be part of the decision-making process to arrive at the FSS which was violated rather than a search-engine to determine relevant statutes.

System 10 can include crimes that are delineated in sections of the FSS or other statutes or ordinances that are outside of the criminal law section. In one embodiment, categories and/or sub-categories of crimes can be listed in alphabetical order based upon common language titles, rather than listed numerically.

In one embodiment, the system 10 can be utilized by individuals in the legal field including attorneys and/or paralegals. System 10 can be part of a training program or can be utilized in applying the law in the judicial system, such as by a prosecutor or clerk of the State Attorney's office.

In one embodiment, system 10 can be provided for use by civilians, such as concerned citizens. In another embodiment, system 10 can be utilized in an academic setting, such as law school, college or high school, including as a web-based application for presentation at multiple sites.

System 10 can utilize a Windows-based, Mac-based, Unix-based, Linux-based, or any other suitable operating system-based user interface environment that can present results in an easy-to-use interface. Various computer programs and languages can be utilized by system 10 including Macromedia Director, Macromedia Flash, Macromedia Fireworks, Adobe Premier Pro, and custom programs, such as those created specifically for interactive use, including the Lingo and Action languages. In one embodiment, system 10 can interface with or be presented by Microsoft Powerpoint.

In one embodiment, system 10 can be part of a training program for students, recruits or even experienced individuals seeking continuing education. For example, a fact pattern can be provided to a user and a series of queries presented to the user to determine a law that has been violated according to the decision flow process or method described above. The fact pattern can be presented to the user separate from the communication device 20, such as through watching a video or reading a set of facts, or the fact pattern can be presented through the communication device 20, such as presenting a video or a document for review on the display 40 of the communication device.

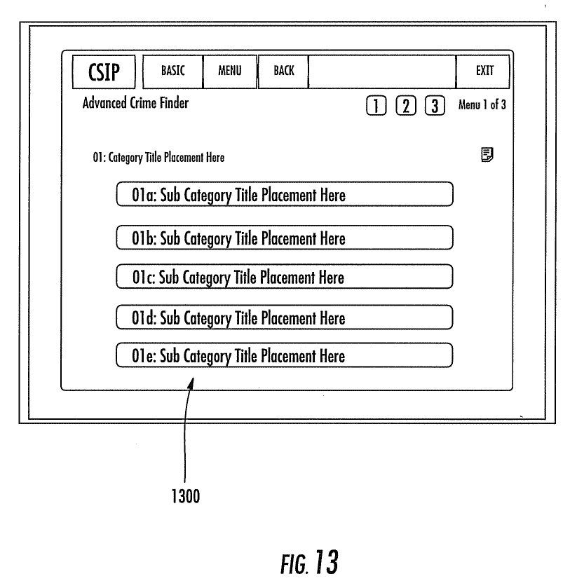

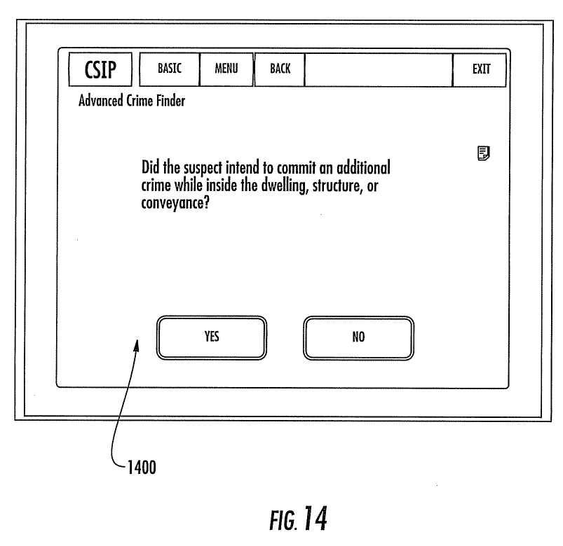

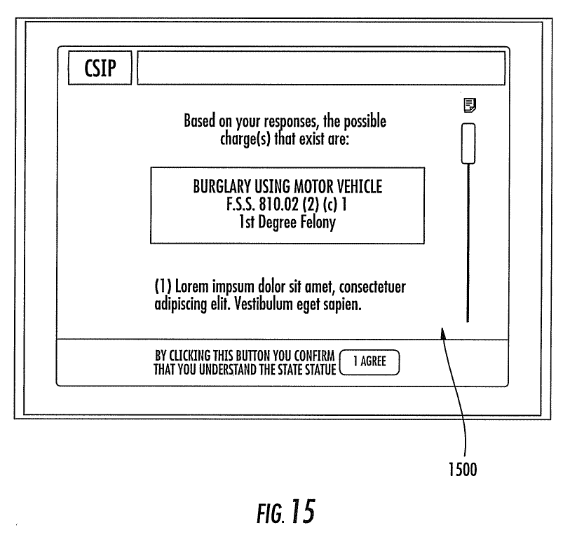

Referring to FIGS. 13-15, another exemplary graphical user interface (GUI) is shown for presenting the series of queries to arrive at the violated law by the above-described decision flow process or method. GUI 1300 allows for presenting all or a portion of a statute title, as well as one or more descriptive terms that may or may not appear in the title or the body of the statute. GUI 1400 can present a fact-based query for which the user can reply yes or no, such as through a touch-sensitive screen, mouse, keyboard or other device. GUI 1500 can present the statute verbatim in a single window with a slide mechanism for sliding text in longer statutes.

The categories, sub-categories and queries that can be selected by a user can be associated with particular laws so that system 10 does not need to perform a search of the laws. This improves run-time and provides a user with definitive answers, rather than a list of search results.

Where applicable, the present embodiments can be realized in hardware, software or a combination of hardware and software. Any kind of computer system or other apparatus adapted for carrying out the methods described herein is suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

The term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A system for determining a law that has been violated by a suspect, the system comprising:
a user interface to receive user inputs and to present queries and a plurality of answers to each of the queries, wherein the user inputs are selections of the plurality of answers; and
a processor to determine a next one of the queries to be presented based on a selection of one of the plurality of answers to a previous query and to determine the law that has been violated based on each of the selections of the plurality of answers,
wherein the processor is in communication with the user interface, wherein the queries are based on elements of the law, and wherein the user interface presents the law that has been violated.

2. The system of claim 1, wherein at least one of the queries is based on a fact pattern associated with the suspect.

3. The system of claim 1, wherein at least one of the queries uses one or more terms that are associated with the elements of the law, and wherein the one or more terms are not recited in the law.

4. The system of claim 1, wherein the user interface and the processor are incorporated into a mobile communication device.

5. The system of claim 4, wherein the mobile communication device is in wireless communication with a centralized server for transmitting at least one of the user inputs and the law that has been violated to the centralized server.

6. The system of claim 1, wherein the user interface comprises at least one of a graphical user interface and a speech recognition interface.

7. The system of claim 1, wherein the processor generates at least a portion of an arrest document based at least in part on the determination of the law that has been violated.

8. The system of claim 7, wherein the user inputs comprise data associated with the suspect, and wherein the processor generates the at least a portion of the arrest document based on the determination of the law that has been violated and the data associated with the suspect.

9. The system of claim 1, wherein the processor determines the next one of the queries to be presented and determines the law that has been violated using a web-based application.

10. The system of claim 1, wherein the user interface and the processor are incorporated into a communication device, and wherein the processor determines the next one of the queries to be presented and determines the law that has been violated using a computer program that is not installed in the communication device.

11. The system of claim 1, wherein the user interface is incorporated into a mobile communication device that is in communication with a centralized server for transmitting at least one of the user inputs and the law that has been violated to the centralized server, and wherein the centralized server generates an arrest document based at least in part on at least one of the user inputs and the law that has been violated.

12. The system of claim 1, wherein the user interface presents the law that has been violated verbatim.

13. A communication device comprising:
a controller to receive user inputs and to present queries and a plurality of answers to each of the queries, wherein the user inputs are selections of the plurality of answers, wherein the controller determines a next one of the queries to be presented based on a selection of one of the plurality of answers to a previous query, wherein the controller determines a law that has been violated by a suspect based on each of the selections of the plurality of answers, wherein the queries are based on elements of the law, and wherein the controller presents the law that has been violated.

14. The communication device of claim 13, wherein at least one of the queries uses one or more terms that are associated with the elements of the law, and wherein the one or more terms are not recited in the law.

15. The communication device of claim 13, wherein at least one of the queries is based on a fact pattern associated with the suspect and the law that has been violated.

16. The communication device of claim 13, wherein the controller is incorporated into a mobile communication device with a user interface, and wherein the mobile communication device is in wireless communication with a centralized server for transmitting at least one of the user inputs and the law that has been violated to the centralized server.

17. The communication device of claim 13, wherein the controller determines the next one of the queries to be presented and determines the law that has been violated using a web-based application.

18. The communication device of claim 13, wherein the controller determines the next one of the queries to be presented and determines the law that has been violated using a computer program that is not installed in the communication device.

19. A computer readable program embodied in an article of manufacture comprising computer readable program instructions for determining a law that has been violated by a suspect, said program comprising:
program instructions for causing the computer to present queries and a plurality of answers to each of the queries, wherein the queries are based on elements of the law;
program instructions for causing the computer to receive user inputs comprising selections of the plurality of answers;
program instructions for causing the computer to determine a next one of the queries to be presented based on a selection of one of the plurality of answers to a previous query; and
program instructions for causing the computer to determine the law that has been violated based on each of the selections of the plurality of answers.

20. The program of claim 19, further comprising program instructions for causing the computer to present the law that has been violated.

21. A method for determining a criminal law or traffic ordinance that has been violated, the method comprising:
presenting on a user interface a plurality of categories of criminal laws or traffic ordinances, wherein the plurality of categories use one or more terms that are associated with the elements of the criminal law or traffic ordinance;
presenting on the user interface a plurality of sub-categories of criminal laws or traffic ordinances, wherein the plurality of sub-categories are determined based on a selection of one of the plurality of categories, wherein the plurality of sub-categories use one or more terms that are associated with the elements of the criminal law or traffic ordinance; and
presenting on the user interface the criminal law or traffic ordinance that has been violated based upon the selection of the plurality of categories and sub-categories.

22. The method of claim 21, wherein the plurality of categories and the plurality of sub-categories are listed in alphabetical order.

23. The method of claim 22, wherein the one or more terms of the plurality of categories and the plurality of sub-categories are not recited in the title of the criminal law or traffic ordinance.

24. The method of claim 21, wherein the user interface is incorporated into a mobile communication device.

25. The method of claim 21, wherein the user interface and a processor are incorporated into a communication device, and wherein the processor determines the plurality of categories and the plurality of subcategories to be presented and determines the criminal law and traffic ordinance that has been violated using a computer program that is not installed in the communication device.

26. The method of claim 21, wherein the user interface presents the criminal law or traffic ordinance that has been violated verbatim.
